(19) United States
(12) Patent Application Publication
(10) Pub. No.: US 2015/0332319 A1
(43) Pub. Date: Nov. 19, 2015

(54) SYSTEM AND METHOD FOR PROVIDING AN ELECTRONIC OFFER MANAGEMENT PLATFORM

(71) Applicant: Catalina Marketing Corporation, St. Petersburg, FL (US)

(72) Inventors: Stephane BAIZEAU, Saint-Cloud (FR); Thomas CANU, Puteaux (FR); Amandine GARCIA, Paris (FR)

(21) Appl. No.: 14/369,623

(22) PCT Filed: Dec. 17, 2012
(86) PCT No.: PCT/US12/70125

§ 371 Date: Jun. 27, 2014

(51) Int. Cl. G06Q 30/02

(52) U.S. Cl. CPC G06Q 30/0251

(57) ABSTRACT

The disclosure relates to systems and methods for providing an electronic offer management platform. Producers may generate offers that are communicated to consumers via a plurality of affiliates that provide the offers to the consumers via their respective assets. By leveraging affiliates who are willing to propagate the offers, the producer may obtain a broad audience of consumers to receive and potentially accept the offers. The system may receive indications that the consumer has accepted an offer, store the offer in one or more offer accounts of the consumer, monitor transaction information related to the consumer to determine whether offer requirements have been satisfied, and credit one or more consumer service accounts with the value of the offer. The system may further facilitate transfer of at least a portion of the balance of the consumer service accounts into a financial account when the balance meets or exceeds a predefined threshold.

### FIELD OF THE INVENTION

The disclosure relates to systems and methods for providing an electronic offer management platform that communicates offers via a network of affiliates, receives acceptances of offers by consumers via the affiliates, associates offers with particular retailer loyalty programs and credits consumer accounts of the value of the offers based on satisfaction of offer requirements.

### BACKGROUND OF THE INVENTION

Offers such as coupons, discounts, promotions, and/or other offers can be cumbersome to use for consumers and cause issues for administering the offers. For example, consumers may not wish to clip and then carry paper coupons. Although electronic coupons stored locally on a consumer device helps alleviate some of this burden, many consumers still do not wish to have to wait while the electronic coupons are being read while checking out in a checkout lane. Some consumers are generally averse to using coupons whether in paper or electronic form.

Even if consumers use coupons and other offers, typically a value of such offers is discounted from a price paid at a point of sale, leaving consumers unable to fully track and accrue/save such values. Additionally, some retailers may not accept certain offers due to technical or other constraints (e.g., being unable to read electronic coupons, not honoring manufacturer coupons, electronic commerce retailers not accepting paper coupons, etc.). For manufacturers, reviewing paper coupons can be cumbersome, fraud from retailers can be costly, and the effective reach of coupons and other offers are limited.

### SUMMARY OF THE INVENTION

The disclosure relates to systems and methods for providing an electronic offer management platform that communicates offers via a network of affiliates, receives acceptances of offers by consumers via the affiliates, associates offers with particular retailer loyalty programs and credits consumer accounts with the value of the offers based on satisfaction of offer requirements.

A system may provide a platform by which producers may generate offers that are communicated to consumers via a plurality of affiliates that provide the offers to the consumers via their respective assets such as websites, mobile applications, campaigns, and/or other assets. By leveraging affiliates who are willing to propagate the offers, the producer may obtain a broad audience of consumers to receive and potentially accept the offers.

The system may include an offer management computer that obtains offers from producers, exposes an interface to affiliates so that the affiliates may propagate the offers using their own assets, receive indications that the consumer has accepted an offer, monitor transaction information related to the consumer to determine whether the offer requirements have been satisfied, and credit a consumer service account with the value of the offer.

When a consumer accepts an offer, the offer management computer may associate the accepted offer with a consumer offer account and monitor transaction information from retailers in order to determine whether the consumer has satisfied one or more offer requirements, such as a requirement to buy one or more items. When the offer management computer determines that the consumer has satisfied the condition of the offer such as by purchasing the one or more items, a value related to the offer may be credited to a consumer service account associated with the consumer. The consumer service account may be related to a particular retailer such that the system may maintain different consumer service accounts for different retailers at which a consumer may shop. When the total value stored in one or more of the consumer accounts, either separately or combined, exceeds a predetermined threshold value, at least a portion of the value may be paid out to the consumer or otherwise used by the consumer.

Using the system, a consumer may accept an offer communicated from various affiliates such as by clicking on an offer presented on a website, a mobile application, an e-mail, and/or other communication channel. The consumer may purchase one or more items related to the offer from a participating retailer such that the offer requirements may be satisfied based on the purchase of the one or more items at one or more of a plurality of retailers. Upon satisfaction of the offer requirements, the value of the offer may be stored at consumer service account, which may be specific to the retailer from which the consumer made the purchase. When the value exceeds a predetermined threshold, the user may access at least a portion of the value.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system of providing an electronic offer management platform, according to an embodiment of the invention.

FIG. 2 illustrates a data flow diagram of an electronic offer management platform, according to an embodiment of the invention.

FIG. 3 illustrates an example of an asset used by an affiliate to communicate an offer, according to an embodiment of the invention.

FIG. 4 illustrates an example of an asset used by an affiliate to communicate an offer, according to an embodiment of the invention.

FIG. 5 illustrates a process of providing an electronic management platform, according to an embodiment of the invention.

### DETAILED DESCRIPTION OF THE INVENTION

The disclosure relates to systems and methods for providing an electronic offer management platform that communicates offers via a network of affiliates, receives acceptances of offers by consumers via the affiliates, associates offers with particular retailer loyalty programs and credits consumer accounts with the value of the offers based on satisfaction of offer requirements.

A system may provide a platform by which producers may generate offers that are communicated to consumers via a plurality of affiliates that provide the offers to the consumers via their respective assets such as websites, mobile applications, telephone campaigns, and/or other assets.

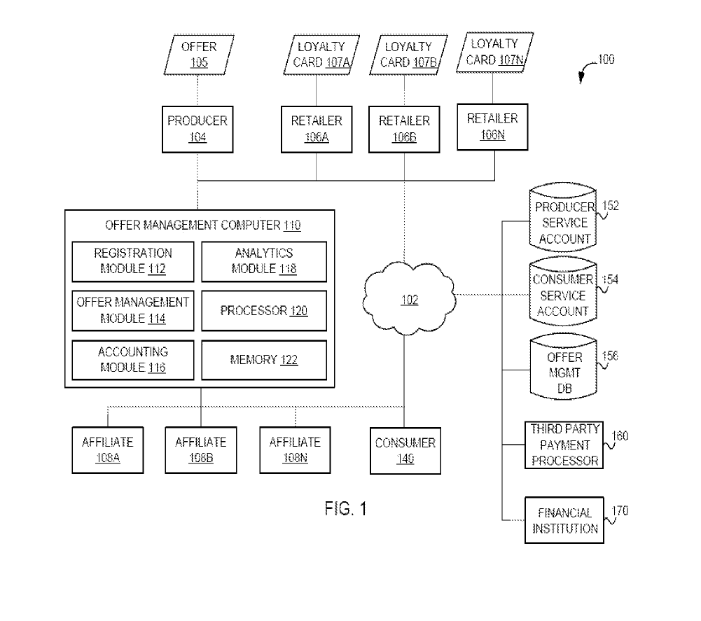

FIG. 1 illustrates a system 100 of providing an electronic offer management platform, according to an embodiment of the invention. System 100 may include a producer 104, one or more retailers 106 (illustrated in FIG. 1 as retailers 106A, 106B, . . . , 106N), one or more affiliates 108 (illustrated in FIG. 1 as affiliates 108A, 108B, . . . , 108N), an offer management computer 110, a consumer 140, a producer service account 152, a consumer service account 154, an offer management database 156 (illustrated as “OFFER MGMT DB 156”), a third party payment processor 160, a financial institution 170, and/or other components.

Recitations of producer 104, retailer 108, affiliates 130, consumer 140, third party payment processors 160, and financial institution 170 as used herein may refer to entities and/or corresponding computing platforms used by those entities.

Offer management computer 110 may include one or more processors 120 configured to execute one or more modules such as a registration module 112, an offer management module 114, an accounting module 116, an analytics module 118, and/or other modules. The various modules may be stored in a memory 122, which may comprise random access memory (RAM), read only memory (ROM), and/or other memory. The memory may store computer-executable instructions to be executed by the processor as well as data that may be manipulated by the processor. The storage media may comprise floppy disks, hard disks, optical disks, tapes, or other storage media for storing computer-executable instructions and/or data.

In some embodiments, registration module 112 may be configured to register various entities to use the platform. For example, registration module 112 may register a consumer 140, a producer 104, a retailer 106, an affiliate 108, and/or other entities.

Consumer 140 may register with the system via registration module 112. Consumer 140 may include an individual, group of individuals (e.g., a household), and/or other entity that consumes items. Consumer 140 may provide one or more identifiers such as a loyalty account identifier for which the consumer is enrolled, a payment card identifier (which may be appropriately de-identified or encrypted), and/or other identifier that may be used to identify the consumer. For example, when the system receives transaction information from retailers in association with a loyalty account identifier or a payment card identifier, the system may be able to determine that the transaction information is related to purchases made by the consumer at the retailer for purposes of determining whether offer requirements have been satisfied.

Consumer 140 may provide one or more payment account identifiers such as for third party payment processors and/or financial accounts where a value of the offer is to be ultimately deposited.

Registration module 112 may store an association between the consumer (e.g., a consumer identifier) and the loyalty program identifier in a database, such as offer management database 156. In this manner, the platform may facilitate cross-chain offers such that consumer 140 may satisfy offer requirements based on one or more purchases at one or more different retailers. Upon registration, a consumer service account 154 may be established. Consumer service account 152 may be used to credit a value of offers that have been accepted by the consumer and for which offer requirements have been satisfied. In some embodiments, different consumer service accounts 152 for a consumer may be established for different retailers 106. For example, a consumer may be associated with different consumer service accounts 152 each corresponding to a particular retailer 106.

A producer 104 may register with the system via registration module 112. Producer 140 may include an entity that wishes to provide an offer 105. Offer 105 may include a promotion such as a coupon and/or other promotion. The offer may have an associated value such as a monetary, reward point, and/or other value. Offer 105 may be associated with one or more offer rules. The rules may specify at least one requirement that must be satisfied such as a purchase of one or more items in order to receive the associated value, the associated value of the offer (e.g., virtual currency, real currency, reward points, etc.), whether the offer is specific to a particular retailer, and/or other rules. An item may include a product, a service, and/or other item. Producer 140 may include an advertiser that promotes the item, a manufacturer that manufactures the item, a service provider that provides the item, and/or other producer that may wish to provide offer 105.

In some embodiments, the one or more requirements may specify that a particular number of items must be purchased, a particular purchase amount must be made (e.g., 30 dollars or other currency), a particular combination of items (e.g., a first item and a second item in the same basket), and/or other types of requirements. The one or more requirements be subject to a time requirement such as spend a particular amount, buy particular items, and/or other requirement within a particular time such as within the next week. The one or more requirements may be satisfied based on purchases may during a single shopping trip, multiple shopping trips, a single retailer, multiple retailers, different types of retailers (e.g., brick-and-mortar, electronic commerce, etc.) and/or other types of purchases.

Upon registration, a producer account 152 may be established that is used to debit a value of offer 105 so that the consumer service account 105 may be credited with the value. Producer 104 may provide to management computer 110 one or more offers 105 to distribute via affiliates 108. For example, producer 104 may wish to leverage the platform and its network of affiliates 108 in order to reach a broad consumer base to which to communicate offers. Producer 104 may enroll or register with the platform via registration module 112 to facilitate communication of such offers. The one or more offers 105 may be stored in association with the producer 104 that provided the offers, such as in offer management database 156.

A retailer 106 may register with the system via registration module 112. Retailer 106 may include an entity that sells or otherwise offers items to consumers such as traditional brick-and-mortar stores, online electronic commerce sites, door-to-door sales providers, sales carts, and/or other retailers. Retailers 106 may use a loyalty card 107 (illustrated in FIG. 1 as loyalty card 107A, 107B, . . . , 107N) that identifies a consumer. A loyalty card may be linked to a loyalty account may include a loyalty identifier that identifies the account (and the consumer). The loyalty account may store transaction information such as items purchased. Consumers may be identified based on their use of the loyalty card and/or consumer identifier at checkout.

Retailer 106 may agree during the registration process to provide transaction information for its consumers (e.g., its consumers who have registered with the platform). A retailer (e.g., an retailer identification) and an identification of its loyalty program (if any) may be stored in association with one another in a database such as offer management database 156.

An affiliate 108 may register with the system via registration module 112. Affiliate 108 may include an entity that provides offer 105 to a consumer via their respective assets. Such assets may communicate offer 106 via various communication channels such as the Internet, a mobile application, Short Message Service (“SMS”) text message, electronic mail, telephone calls, and/or other communication channel. Producer 104, retailer 106, third party offer providers, and/or other entities may act as an affiliate 108.

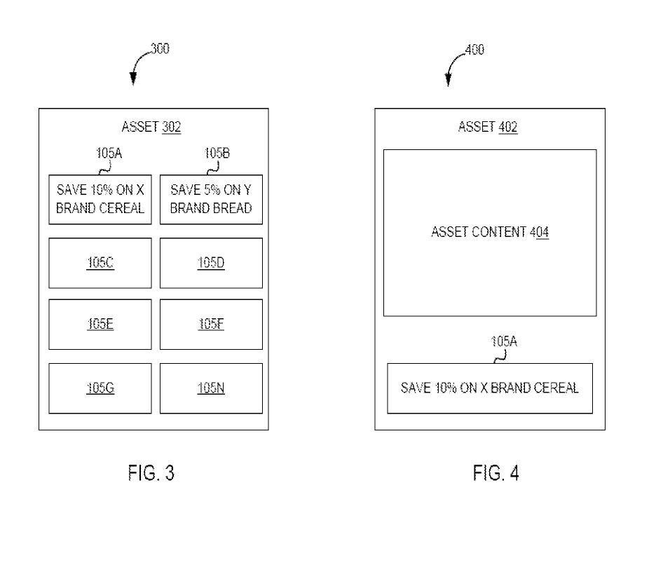

In some embodiments, offer management module 114 may be configured to obtain an offer 105. For example, offers may be obtained from producers 104 and/or offer management database 156 (e.g., for offers previously obtained from producers 104 and subsequently stored at offer management database 156). In some embodiments, offer management module 114 may be configured to expose an interface such as an Application Programming Interface (“API”), webservices, and/or interface that affiliates 108 may use to obtain offers 105 and/or information related to the offers (such as terms and conditions, customer account balances, and/or other information). Affiliates 108 may obtain the offers and communicate the offers, examples of which are described with respect to FIGS. 3 and 4.

In some embodiments, offer management module 114 may receive an indication that consumer 140 has accepted offer 105, which may have been communicated by affiliate 108. Consumer 140 may accept an offer by selecting (e.g., clicking, etc.) an offer on a user interface, responding to an electronic communication, responding to a telephonic or in-person communication, and/or otherwise demonstrating an interest in the offer). Offer management module 114 may store the accepted offer at a customer offer account related to the consumer. The consumer offer account may be stored at offer management database 156 and may include one or more offers accepted by consumer 140.

In some embodiments, the consumer offer account may be associated with or otherwise comprise a loyalty program of the retailer. In these embodiments, different consumer offer accounts maybe associated with or otherwise comprise a corresponding loyalty program. Thus, the platform allows for cross-chain management of offers 105 from producers 104.

In some embodiments, offer management module 114 may receive an indication that the consumer has satisfied a requirement of the accepted offer. For example, offer management module 114 may monitor transactions from relevant retailers to determine whether a purchase of an item related to the offer was made.

In some embodiments, offer management module 114 may monitor transactions from particular retailers for a given accepted offer. For example, offer management module 114 may store associations of accepted offers with different loyalty programs or otherwise different retailers 106. Such associations may be stored in offer management database 156 and be based on consumer designations that certain accepted offers are to be associated with different loyalty programs. For example, an offer may be designated by the consumer to be used in association with a retailer 106A while another offer may be designated by the consumer to be used in association with a retailer 106B. In these embodiments, offer management module 112 may monitor transactions from the particular retailer associated with the accepted offer to determine whether requirements of any coupon accepted by the consumer has been satisfied based on the monitored transaction information.

In some embodiments, offer management module 114 may monitor transactions from participating retailers. For example, the consumer 140 may not designate a retailer 106 to be associated with the accepted offer. In these embodiments, offer management module 112 may monitor transactions from participating retailers to determine whether one or more requirements of any offer accepted by the consumer has been satisfied based on the monitored transaction information.

In some embodiments, affiliates 108 may present a graphical user interface such as a website, a mobile application, and/or other user interface that allows a user to accepted one or more offers from among a plurality of offers. For example, consumer 140 may electronically clip a coupon offered by producer 104 and displayed by affiliate 108. Accepted offers may be stored at a consumer offer account, which may be stored in offer management database 156. Purchases made at a retailer that satisfies one or more requirements of the accepted offer may be associated with the offer at offer management computer 110, which may credit the value of the offer to a consumer service account 154, as discussed in more detail herein.

In some embodiments, offer management module 114 may provide instructions such as hypertext markup language (“HTML”) code to affiliates 108. Affiliates 108 may incorporate the instructions into their assets. The provided instructions may allow offer management computer 110 to track when offers are accepted by consumers 140.

In some embodiments, the instructions may include one or more uniform resource indicator (“URI”) links that may be selected to accept an offer. The URI links may encode an indication of an acceptance of the offer by the consumer. Offer management computer 110 may directly receive the indication (e.g., the URI link may link to a website associated with offer management module 114) and/or indirectly receive the indication (e.g., the URI link may link to a site of the producer who made the offer, and the producer may subsequently report the selection to offer management computer 110).

In some embodiments, the instructions may include scripts such as JAVASCRIPT code that automatically reports (directly and/or indirectly) acceptances of the offer by the user to offer management module 114. In some embodiments, the instructions provided by offer management module 114 to affiliates 108 may be predefined and stored in a memory such as offer management database 156. In some embodiments, the instructions may be configurable to suit individual needs of the affiliates.

Whichever ones of the foregoing or other ways in which to receive the acceptance of the offer is used, affiliate interface 108 may cause the indication that the offer 105 has been accepted by consumer 140 to be stored in a memory such as offer management database 156. The acceptance of the offer may be associated with consumer 140. In some embodiments, for example, consumer 140 may be logged onto a webpage offered by affiliate 108 and such logon may be used to identify the consumer. In embodiments where consumer 140 is not logged on to a site of the affiliate, upon accepted of the offer 105, consumer 140 may be prompted to input a consumer identifier or otherwise logon.

In some embodiments, accounting module 116 may be configured to credit consumer service account 154 with the value of the offer based on the indication that the consumer has satisfied the offer requirements. In some embodiments, accounting module 116 may debit a producer service account 152 with the value of the offer based on the indication that the consumer has satisfied the offer requirements.

In some embodiments, accounting module 116 may determine whether a value in one or more of the consumer service accounts 154 meets or exceeds a threshold value. In some embodiments, accounting module 116 may periodically (such as hourly, daily, weekly, etc.) determine whether the threshold value has been met or exceeded. The threshold value may be configurable by one or more users such as the consumer. Such threshold values may be applied individually for each consumer service account 154 or collectively across different consumer service accounts 154. When the threshold value has been met or exceeded, accounting module 116 may provide at least a portion of the value of one or more of the consumer service accounts 154. The provided value may be facilitated via third party payment processor 160 and/or financial institution 170. In this manner, values related to offers for which its offer requirements have been satisfied may be accumulated in a single consumer service account 154 and/or across different consumer service accounts 154 and credited to various payment and financial accounts. In some embodiments, account module 116 may credit such accounts automatically when the threshold values are reached and/or in response to a request by the consumer.

Third party payment processor 160 may include various third party payment entities such as PAYPAL, GOOGLE WALLET, and/or other payment processors that can transfer funds to and from one or more financial accounts. Financial institution 170 may include various entities such as banks that maintain financial accounts such as credit card accounts, checking or savings accounts, cashback accounts retailers use for providing cash to consumers at the point-of-sale, and/or other financial accounts.

The consumer need not carry a physical copy of the offer such as a paper coupon or an electronic copy of the offer such as an electronically clipped coupon. Instead, the consumer need only present information that identifies the consumer (e.g., a loyalty card, a payment card, and/or other identification) to a retailer that has registered with the platform. Furthermore, the system allows the user to accumulate the value of offers rather than receiving such value individually at the time of purchase or other satisfaction of a requirement related to the offer.

In some embodiments, affiliates 108 may be compensated for communicating the offers. In these embodiments, accounting module 116 may update compensation information that indicates a level of compensation to be provided to the affiliates. For example, compensation information may include a number of times that an offer was displayed/communicated by an affiliate, a number of times that an offer was redeemed, and/or other information that may be used to determine a level of compensation to be paid to the affiliate. In some embodiments, the compensation to be paid to the affiliate and/or the system may be debited from a producer account such as producer service account 152. For example, producers may pay a fee to the system for the right to use the affiliate network and/or other resources provided by the system.

In some embodiments, analytics module 118 may be configured to track performance results of offers such as metrics that indicate offers that have been accepted, offers that have been redeemed, affiliates 108 that communicated the accepted and/or redeemed offers, retailers 106 at which relevant purchases were made, and/or other metrics that indicate performance results of offers. Analytics module 118 may generate various reports that include the metrics to facilitate review and enhancements to campaigns that include the offers.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

In FIG. 1 and other drawing Figures, different numbers of entities than depicted may be used. For example, although only a single producer 104 is illustrated, more than one producer 104 may use the platform to propagate offers.

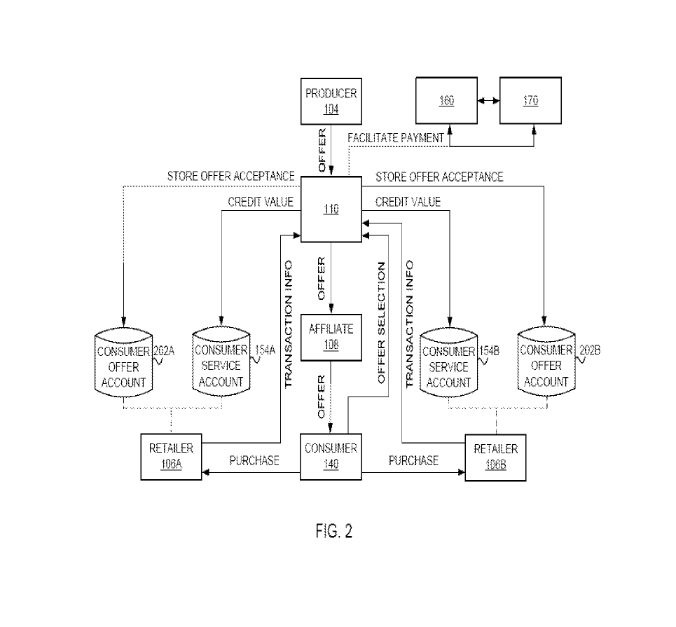

FIG. 2 illustrates a data flow diagram 200 of an electronic offer management platform, according to an embodiment of the invention. Although retailer 106A is illustrated as being associated with a consumer service account 154A and a consumer offer account 202A and retailer 106B is illustrated as being associated with a consumer service account 154B and a consumer offer account 202B, a single consumer service account and a single consumer offer account may be used in relation to both retailers.

Producer 104 may provide one or more offers to offer management computer 110. In some embodiments, an offer may be associated with one or more rules. Offer management computer 110 may expose an interface or otherwise provide the offers to an affiliate 108, who uses various assets to communicate the offer to consumer 140.

Consumer 140 may accept (e.g., click on or otherwise indicate an interest in) one or more of the offers. Offer management computer 110 may directly or indirectly receive the acceptance of the offer. In some embodiments, offer management computer 110 may determine whether the accepted offer should be associated with a particular retailer. This determination may be made in various ways. For example, consumer 140 may indicate that a selected offer should be used in relation to a particular retailer, the rules associated with the offer may indicate that the offer should be used in relation to a particular retailer, and/or other method by which the offer is to be associated with a particular retailer may be used. In some embodiments, the offer is associated all participating retailers 106.

Offer management computer 110 may store the offer in relation to consumer offer account 154A and/or consumer offer account 154B such that the offer may be applicable to a corresponding retailer. For example, when the offer acceptance is stored in consumer offer account 402A and a purchase is made at retailer 106A, then the value of the offer may be credited to consumer service account 154A. Likewise, when the offer acceptance is stored in consumer offer account 202B and a purchase is made at retailer 1068, then the value of the offer may be credited to consumer service account 154B.

Consumer 140 may make relevant purchases of items required by the offer at one or more different retailers 106. During the purchase transaction, consumer 140 may provide identification such as a retailer-specific loyalty card, a payment card such as a credit card that was registered with the platform, a Near Field Communications (“NFC”) identification, and/or other types of identifications. Participating retailers may communicate transaction information that includes purchases made by consumer 140. Offer management computer 110 may determine that a purchase requirement related to the offer was made by consumer based on transaction information received from participating retailers 106A, 1068.

Offer management computer 110 may add values related to offers for which offer requirements have been satisfied in each consumer service account 154A, 154B such that when the requirements related to the offer have been satisfied, the value of the offer is added to an existing balance of the consumer service account. In some embodiments, when a balance or value of a given single consumer service account meets or exceeds a predetermined threshold, at least a portion of the balance may be made available to consumer 140. In some embodiments, when a total balance of more than one or all of the consumer service accounts for a consumer meets or exceeds a predetermined threshold, at least a portion of the balance may be made available to consumer 140.

In some embodiments, the availability of the balance may be communicated to consumer 140. Consumer 140 may request that a certain value be credited to a payment account. Offer management server 110 may cause the certain value to be credited to a payment account via third party payment processor 160 and/or financial institution 170.

FIG. 3 illustrates an example 300 of an asset 302 used by an affiliate to communicate an offer, according to an embodiment of the invention. Asset 302 may include a website, a mobile application, and/or other interface that displays a plurality of selectable offers 105 (illustrated in FIG. 3 as offers 105A-N). Only offers 105A and 105B are labeled with offer text for convenience. Additionally, offer 105 may include text, graphics, multimedia, and/or other content. Upon acceptance of an offer 105, the accepted offer may be stored in association with at least one user account as described herein.

The consumer may be identified in various ways. In some embodiments, for example, a consumer may log on to access asset 302 such that the identity of the consumer is known. In some embodiments, a cookie or other data file may be deposited onto a consumer device such that the identity of the consumer may be extracted from the cookie or other data file. In some embodiments, upon selection of an offer 105 to accept the offer, the consumer may be prompted to provide a consumer identification known by the platform (such as a consumer identification that was provided during the registration process). In some embodiments, asset 302 (if not part of offer management computer 110 illustrated in FIG. 1) may communicate the accepted offer to offer management computer 110.

In some embodiments, asset 302 may include instructions provided by offer management computer 110 such that the accepted offers may be automatically obtained based on the included instructions.

FIG. 4 illustrates an example of an asset 402 used by an affiliate to communicate an offer 105, according to an embodiment of the invention. As illustrated, offer 105A may be presented as a banner or other type of advertisement that is displayed alongside asset content 404. For example, an affiliate may include a website operator that publishes asset content 404. The website operator may publish offer 105A as an advertisement that is displayed along or adjacent to asset content 404. Offer management computer 110 (illustrated in FIG. 1) may receive an indication that the offer was accepted, as described herein. As also described herein, the identity of the consumer perusing asset 402 may be identified in various ways.

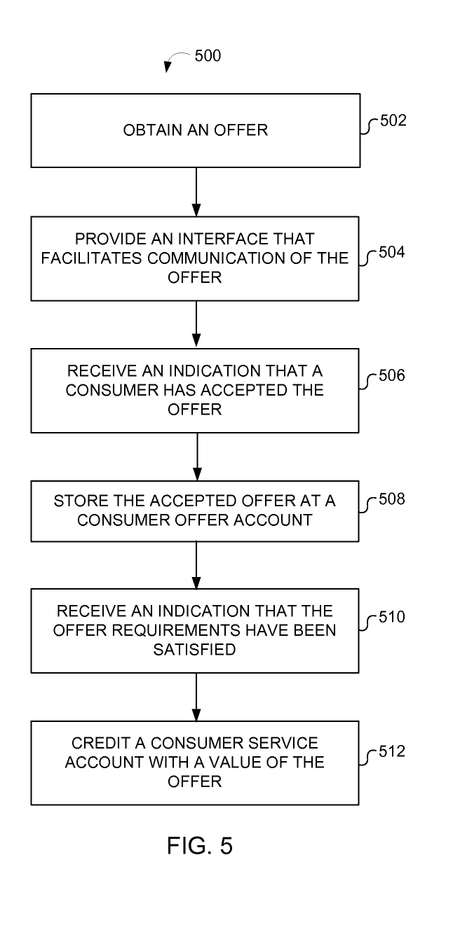

FIG. 5 illustrates a process 500 of providing an electronic management platform, according to an embodiment of the invention. The various processing operations and/or data flows depicted in FIG. 5 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 502, an offer having an associated value and at least one requirement to be satisfied may be obtained. In an operation 504, an interface that communicates the offer to one or more of affiliates that individually communicate the offer to a consumer via their respective assets may be provided. In an operation 506, an indication that the consumer has accepted the offer may be received. In an operation 508, the accepted offer may be stored at a consumer offer account related to the consumer. In an operation 510, an indication that the consumer has satisfied the at least one requirement may be received. In an operation 512, a consumer payment account related to the consumer with the value of the offer may be credited.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A system configured to provide an electronic offer management platform, the system comprising:
one or more processors configured to execute computer program modules, the computer program modules comprising:
an offer management module configured to:
obtain an offer having an associated value and at least one requirement to be satisfied to obtain the associated value;
provide an interface that communicates the offer to one or more of affiliates that individually communicate the offer to a consumer via their respective assets;
receive an indication that the consumer has accepted the offer;
store the accepted offer at a consumer offer account related to the consumer;
receive an indication that the consumer has satisfied the at least one requirement; and
an accounting module configured to:
credit a consumer service account related to the consumer with the associated value of the offer.

2. The system of claim 1, wherein the at least one requirement comprises a purchase of one or more items.

3. The system of claim 1, wherein the accounting module is further configured to:
determine whether a total value in the consumer service account meets or exceeds a predetermined threshold value; and
provide at least a portion of the total value to the consumer when the total value in the account meets or exceeds the predetermined threshold value.

4. The system of claim 1, wherein the accounting module is further configured to:
provide at least a portion of a total value in the consumer service account via one or more third party payment processors.

5. The system of claim 1, wherein the consumer service account is related to a first retailer and wherein at least a second consumer service account is related to at least a second retailer.

6. The system of claim 1, wherein the account module is further configured to:
credit the consumer service account with the associated value of the offer when the consumer has satisfied the at least one requirement in relation to the first retailer; or
credit the second consumer service account with the associated value of the offer when the consumer has satisfied the at least one requirement in relation to the second retailer.

7. The system of claim 1, wherein the offer account is associated with a particular loyalty program of a particular retailer.

8. The system of claim 1, wherein the offer management module is further configured to:
obtain transaction information from a retailer;
determine that the at least one requirement has been satisfied based on the transaction information.

9. A computer-implemented method of providing an electronic offer management platform, the method being implemented in a computer that includes one or more processors configured to execute computer program modules, the method comprising:
an offer management module configured to:
obtaining, by an offer management module, an offer having an associated value and at least one requirement to be satisfied to redeem the value;
providing, by the offer management module, an interface that communicates the offer to one or more of affiliates that individually communicate the offer to a consumer via their respective assets;
receiving, by the offer management module, an indication that the consumer has accepted the offer;
storing, by the offer management module, the accepted offer at a consumer offer account related to the consumer;
receiving, by the offer management module, an indication that the at least one requirement has been satisfied; and
crediting, by an accounting module, a consumer service account related to the consumer with the associated value of the offer.

10. The method of claim 9, wherein the at least one requirement comprises a purchase of one or more items.

11. The method of claim 9, the method further comprising:
determining, by the accounting module, whether a total value in the consumer service account meets or exceeds a predetermined threshold value; and
providing, by the accounting module, at least a portion of the total value to the consumer when the total value in the account meets or exceeds the predetermined threshold value.

12. The method of claim 9, the method further comprising:
providing, by the accounting module, at least a portion of a total value in the consumer service account via one or more third party payment processors.

13. The method of claim 9, wherein the consumer service account is related to a first retailer and wherein at least a second consumer service account is related to a at least a second retailer.

14. The method of claim 9, the method further comprising:
crediting, by the accounting module, the consumer service account with the associated value of the offer when the at least one requirement has been satisfied in relation to the first retailer; or
crediting, by the accounting module, the second consumer service account with the value of the offer when the at least one requirement has been satisfied in relation to the second retailer.

15. The method of claim 9, wherein the offer account is associated with a particular loyalty program of a particular retailer.

16. The method of claim 9, the method further comprising:
obtaining, by the offer management module, transaction information from a retailer;
determining, by the offer management module, that the at least one requirement has been satisfied based on the transaction information.
